(19) United States
(12) Patent Application Publication
(10) Pub. No.: US 2008/0271550 A1
(43) Pub. Date: Nov. 6, 2008

(54) Gyroscope Apparatus

(76) Inventor: Daniel Muessli, Muensingen (CH)

Correspondence Address: BAKER & DANIELS LLP, 300 NORTH MERIDIAN STREET, SUITE 2700, INDIANAPOLIS, IN, 46204, US

(21) Appl. No.: 11/547,063

(22) PCT Filed: Apr. 2, 2004
(86) PCT No.: PCT/SG2004/000079

§ 371 Date: Sep. 29, 2006

(51) Int. Cl. G01C 19/02

(52) U.S. Cl. 74/5.7; 74/5.95

(57) ABSTRACT

Gyroscope apparatus (100) having a compact size is disclosed herein. The apparatus (100) comprises a flywheel (402) having a centre cavity (401) and being arranged to be rotated about a Z-axis. The apparatus (100) further includes two motors (300, 350) and a gear assembly (200) driven by the two motors and arranged to rotate two shafts (102, 104) disposed along the Z-axis, thus rotating the flywheel about a Y-axis which is orthogonal to the Z-axis. Since flywheel (402) is disposed around the motors (300, 350) and the gear assembly (200), the apparatus can be made very compact.

### BACKGROUND AND FIELD OF THE INVENTION

This invention relates to a gyroscope apparatus, more particularly but not exclusively to a control moment gyroscope apparatus.

Gyroscopes have been in existence for many years and have been used in numerous types of applications. For example, gyroscopes have been used in navigation systems of planes and ships, and also to provide attitude control in a moving object, including spacecrafts and satellites, so as to control the movement of the object. In the latter application, the gyroscope is commonly known as a Control Moment Gyroscope (CMG).

A CMG typically includes a gyroscopic wheel with a spin axle through the wheel's centre, and an electric motor arranged to rotate the spin axle and thus spinning the gyroscopic wheel to a high speed to produce angular momentum. Further, the gyroscope is gimballed at ends of a gimbal axis which is orthogonal to the spin axis. Another motor located at one end of the gyroscope is then used to rotate the gyroscope about the gimbal axis. Since the gyroscopic wheel is of sufficient mass and is spinning at such a rate to produce angular momentum, any movement of the gyroscopic wheel out of its plane of rotation would induce torque about an axis which is orthogonal to the spin and the gimbal axes. This torque is then used to urge the moving object in a desired manner. However, with such an arrangement, the CMG is not compact.

### SUMMARY OF THE INVENTION

In a first aspect of the invention, there is provided gyroscope apparatus comprising a flywheel arranged to be rotated about a first axis; a rotation device arranged to rotate the flywheel about a second axis which is orthogonal to the first axis, the flywheel being disposed around the rotation device.

An advantage of the described embodiments of the present invention is that since the flywheel is disposed around the rotation device, the flywheel is being rotated about the second axis from inside and not from outside of the flywheel and thus this makes the apparatus more compact.

Preferably, the apparatus further comprises a flywheel motor arranged to rotate the flywheel about the first axis, the flywheel being disposed around the flywheel motor. The flywheel motor may be disposed around the rotation device.

Preferably, the flywheel motor includes a motor stator and a ring magnet, the ring magnet being rotatable in concert with the flywheel about the first axis. Typically, the motor stator is annular shape.

Alternatively, the gyroscope apparatus may comprise a flywheel motor generator device selectively arranged to rotate the flywheel about the first axis or to convert the rotation of the flywheel into electrical energy. Preferably, the flywheel is arranged around the motor-generator device.

Preferably, the rotation device further comprises a gear assembly arranged to rotate the flywheel, and a gear motor arranged to drive the gear assembly. The gyroscope apparatus may then further include two axles arranged in end-to-end relationship along the first axis, the two axles being connected to the gear assembly.

It is preferred that the gear assembly includes a pinion gear arranged to be rotated by the gear motor, first pair of opposing bevel gears meshed with respective parts of the pinion gear, second pair of opposing bevel gears connected to the first pair of opposing bevel gears and being arranged to rotate in accordance with the first said pair, and two opposing axle gears meshed with respective second pair of opposing bevel gears, each axle gear fixedly connected to a corresponding said axle, whereby rotation of the pinion gear is rotates both axles in opposing directions to each other.

Advantageously, the gear motor is disposed around the gear assembly.

The gear motor may include a motor stator and a motor rotor, the rotor being disposed around the motor stator. It is preferred that the rotor encloses the gear assembly entirely to make the arrangement more compact. The gear motor may include a ring magnet disposed between the stator and rotor. With the above arrangement, the pinion gear is preferably connected to the rotor, the pinion gear being arranged to be rotated in response to the rotation of the rotor.

Alternatively, the rotor may include two rotor halves and the gear motor includes two motor stators arranged to drive the respective rotor halves. In this case, the motor may have two ring magnets with each magnet being disposed between corresponding rotor half and motor stator. In this arrangement, the pinion gear would preferably be connected to one of the rotor halves so that the pinion gear is arranged to be rotated in response to the rotation of the connected rotor half.

Further, the apparatus may comprise a wheel connected to a free end of each axle, the wheel being arranged to be supported on a circular support and being moved around the circular support by the radial rotation of the corresponding axle. Preferably, the wheels are geared wheels and the circular support is a geared track.

The apparatus may further include two side covers connected to sides of the flywheel to enclose the rotation device therebetween.

The apparatus may also include means to rotate the flywheel about a third axis which is orthogonal to the first and second axes. In an alternative, the rotation means may be arranged to the flywheel about a third axis which is at an oblique angle with respect to the second axis. In these arrangements, the apparatus may comprise a flywheel enclosure, and a torque gear surrounding an outer periphery of the enclosure, the torque gear being rotatable to rotate the enclosure and the flywheel about the third axis. Advantageously, the gear track is disposed along an inner periphery of the enclosure. In other words, the inner periphery surrounds the gear track.

Preferably, the enclosure is spherical in shape and the torque gear is circular.

The apparatus may include a torque pinion gear meshed with the torque gear, and a motor arranged to drive the torque pinion gear. Alternatively, the apparatus may include a motor-generator device selectively arranged to drive the torque pinion gear or to convert movement of the torque pinion gear into electrical energy.

In some applications, the motor described herein may be a stepper motor. In some applications, the rotation device may include a motor-generator device selectively arranged to rotate the flywheel about the second axis or to convert the rotation of the flywheel into electrical energy. Preferably, the rotation device further comprises a gear assembly selectively arranged to rotate the flywheel is about the second axis or to be driven by rotation of the flywheel.

In some applications, the apparatus may include a conversion device, such as a generator, arranged to convert the rotation of the flywheel into electrical energy. Preferably, the flywheel is annular in shape.

In a second aspect of the present invention, there is provided a gyroscope apparatus comprising a flywheel arranged to be rotated about a first axis and a second axis which is orthogonal to the first axis; and a conversion device arranged to convert the rotation of the flywheel about the second axis to electrical energy, the flywheel being disposed around the generator.

The described embodiment of the present invention can be used in a large number of applications for example, in a celestial device such as a satellite, a vehicle such as bicycles cars, planes, ships and trains, or even household appliances. Depending on its application, a single gyroscope apparatus of the present invention may be used or a combination of two.

### BRIEF DESCRIPTION OF THE DRAWINGS

An embodiment of the invention will now be described, by way of example, with reference to the accompanying drawings in which;

FIG. 1 is a perspective view of a gyroscope apparatus according to a preferred embodiment of the present invention having X, Y and Z rotation axes;

FIG. 2 shows an exploded view of the gyroscope apparatus along the Z-axis of FIG. 1 which includes a gyroscope and a gear assembly;

FIG. 3 is a close-up exploded view of the gear assembly of FIG. 2;

FIG. 4 includes FIGS. 4a to 4d which show various parts of the gear assembly of FIG. 2 in an assembled state;

FIG. 5 is a cross-section view of the gyroscope and gear assembly along the Z-axis;

FIGS. 6a and 6b illustrate how the gyroscope and gear assembly of FIG. 2 is being supported on a hemispheric base of the apparatus of FIG. 1;

FIGS. 7a and 7b illustrate a base of the apparatus of FIG. 1 including a set of gears for rotating the gyroscope and gear assembly of FIG. 2 about the X-axis;

FIG. 8 is another view of the apparatus of FIG. 1 with some of the outer parts made transparent to see the internal components; and

FIGS. 9 to 13 show different applications in which the apparatus of FIG. 1 can be used.

### DETAILED DESCRIPTION OF THE PREFERRED EMBODIMENT

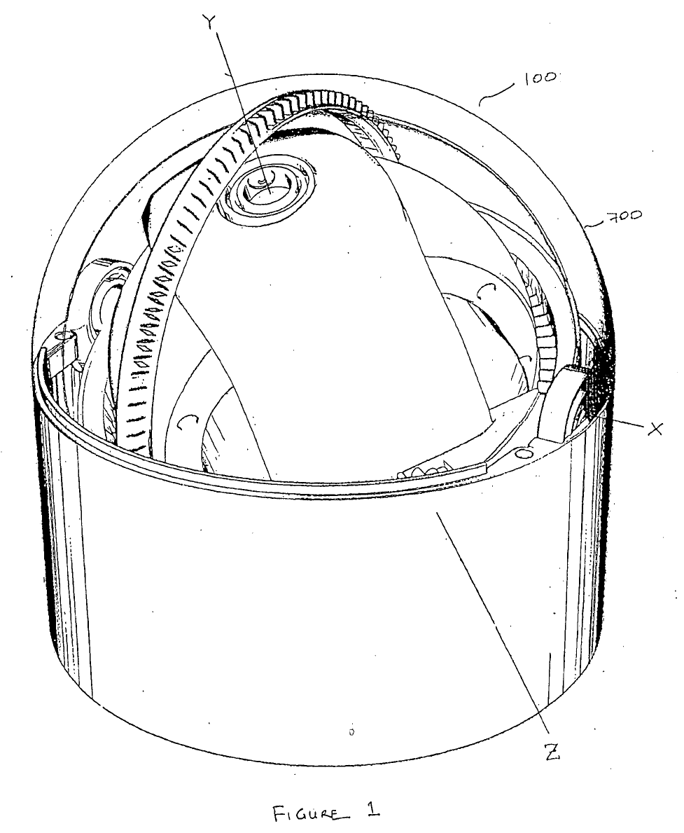

FIG. 1 shows a perspective view of a gyroscope apparatus 100 according to a preferred embodiment of the present invention which has three main axes of rotation: X, Y and Z.

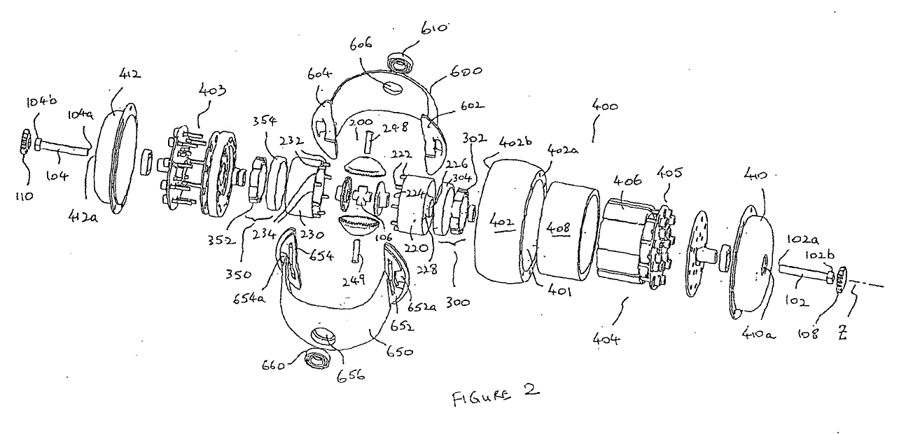

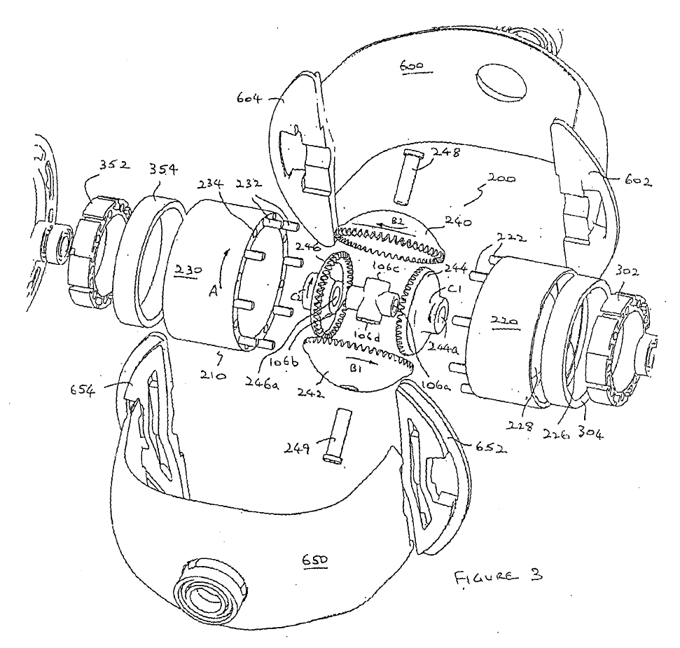

FIG. 2 is an expanded view of the gyroscope apparatus 100 along the Y and Z-axes. As illustrated, the gyroscope apparatus 100 comprises two independent cylindrical shafts or axles 102,104 arranged along the Z-axis with first ends 102a,104a rotatably received in opposing ends 106a,106b of a cross-connector 106 (see FIG. 3). Each of the shafts' second ends is in the form of a square stud 102b,104b which is connected to a geared wheel 108,110 and thus when the shafts 102,104 rotate radially about the Z-axis, the wheels 108,110 rotate accordingly.

The gyroscope apparatus 100 has a rotation device comprising a shaft gear assembly 200 arranged to rotate the shafts 102,104 and two gear assembly motors 300,350 arranged to drive the gear assembly 200 and this is illustrated more clearly in FIGS. 3 and 4. The gear assembly 200 has a hollow rotational member 210 which comprises two ring halves 220,230 that function as rotors. At one end of each ring half 220,230, there are protruding locking pins 222,232 and pin holes 224,234 arranged along the brim of the ring half with a locking pin 222 of one half 220 arranged to be received in a corresponding pin hole 234 of the other half 230. Each ring half 220,230 has a centre opening 226,236 (only opening 226 is shown in FIG. 3) through which the respective shaft 102,104 is inserted to be received in the cross-connector 106. When the locking pins 222,232 are received in corresponding pin holes 224,234, the ring halves 220,230 are locked in place and thus the entire member 210 is rotatable (when driven) about the shafts 102,104.

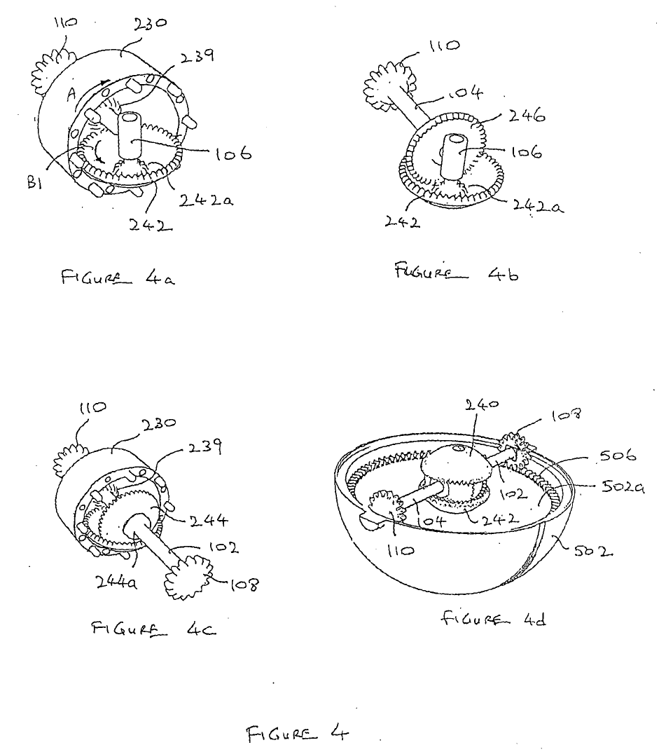

The gear assembly 200 preferably has ball bearings 212 arranged between the openings 226,236 and the shafts 102,104 to facilitate rotation of the rotational member 210 relative to the shafts 102,104 and the bearings 212 are shown more clearly in FIG. 5 which is a cross-sectional assembled view of part of the gyroscope apparatus along the Z-axis.

At the other end of each ring half 220,230, a funnel-like projection 228,238 is arranged to receive a respective gear motor 300,350 which includes a stator 302,352 and a ring magnet 304,354 to rotate the respective gear half 220,230 (and thus the rotational member 210). It should be apparent that the ring magnets 304,354 are suitably polarised to be magnetised for moving the ring halves 220,230. It should also be apparent that only one motor 300,350 is needed to rotate the rotational member 210 (and thus the member 210 may simply be a single unit and not two halves) but two motors are preferred to provide more power. Preferably, the motors 300,350 are brushless D.C. engines. Alternatively, depending on the application, the motors 300,350 may be stepper motors.

Further, one of the ring halves 220,230 has an internal pinion gear 239 which rotates in concert with the rotation of the rotational member 210 and in this case, the gear 239 is located inside the left half 230. FIG. 4a illustrates the pinion gear 239 of this ring half 230. The pinion gear 239, which has the Z-axis as the centre axis is then used to drive two opposing bevel gears 240,242 to rotate them in opposite directions.

The two bevel gears 240,242 are mounted along an axis substantially orthogonal to the Z-axis since the two bevel gears 240,242 are pivoted for rotation at opposing ends 106c,106d of the cross connector 106 using pivoting pins 248,249 (see FIG. 3). Each bevel gear 240,242 also has an internal gear 240a,242a which meshes with opposing shaft drive gears 244,246 and this is illustrated in greater detail in FIG. 4b (with the ring half 230 removed and showing part of the cross connector 106).

Each shaft drive gear 244,246 has a centre opening 244a,246a through which the respective shafts 102,104 is inserted so that each gear 244,246 is fixedly connected thereto to rotate the shafts 102,104 as each gear 244,246 is being rotated. FIG. 4c illustrate connection between one of the shaft 102 and one of the drive gears 244 (with the ring half 220 not shown).

FIG. 4d shows an assembled view of the bevel gears 240,242 and the drive gears 244,246 supported by the shafts 102,104.

Referring again to the exploded view of FIG. 2, the gyroscope apparatus 100 includes a gyroscope 400 for producing angular momentum about the Z-axis. The gyroscope 400 includes an annular flywheel 402 and a gyro rotation device in the form of a gyro motor 404 supported along the Z-axis. The flywheel 402 has a centre cavity or opening 401 for receiving the gyro motor 404 which includes an annular stator 406, two stator plates 403,405 for wire coils, and a ring magnet 408 arranged to rotate the flywheel 402. The two stator plates 403,405 are used to engage the stator 406 from two opposing ends so as to support the stator 406 when the plates 403,405 are supported from the shafts 102,104. In this embodiment, the gyro motor 404 is a brushless D.C. motor.

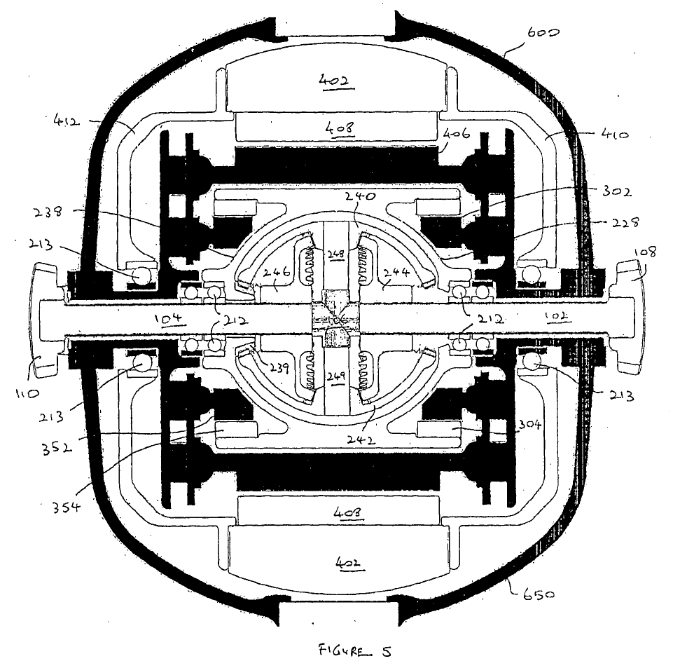

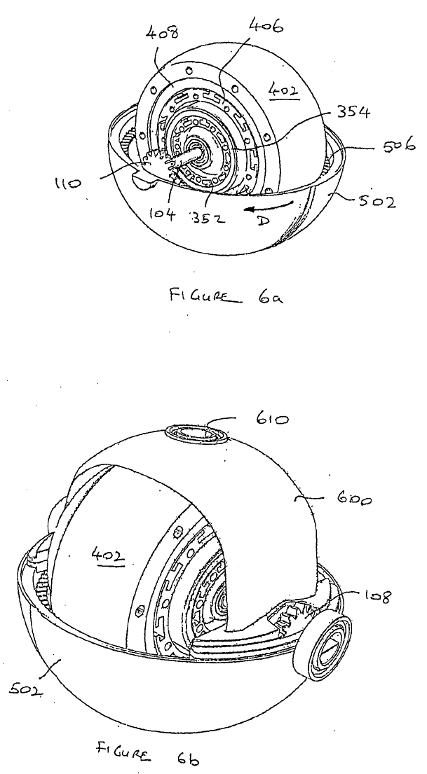

FIG. 6a shows the flywheel 402, gyro motor 404, the gear assembly 200 and the associated gear motors 300,350 being arranged on the shaft 102 and 104.

The apparatus 100 further includes two side covers 410,412 connected to sides 402a,402b of the flywheel 402 thus enclosing the gyro motor 404, the gear assembly 200, the gear motors 300,350 inside the cavity 401 of the flywheel 402. As illustrated in FIG. 2, each of the two side covers 410,412 has a centre hole 410a,412a for respective shaft 102,104 to be inserted therethrough and each side cover 410,412 is supported by the shafts 102,104 via ball bearings 213 (see FIG. 5) so as to facilitate rotation of the side covers 410,412 and the flywheel 402 about the Z-axis. Since the gears assembly 200 and the gear motors 300,350 are arranged inside the flywheel, it would be appreciated that this arrangement allows the gyroscope 400 and thus the apparatus 100 to be adapted to a very small size. For ease of description, the assembly of the flywheel 402, the covers 410,412 and the parts inside the flywheel are collectively called the gyro and motor assembly 450.

A cross sectional view along the Z-axis plane of the apparatus 100 in an assembled state is shown in FIG. 5, and it should be noted that shaded portions of FIG. 5 represent the stationary parts of the apparatus 100 and these include the three stators 302,352,406. Also, spaces between the stator plates 403,405 and the side covers 410,412 can be used to house electronic circuitry that is needed to drive the motors 300,350,404 (mounted on the fix stator plates 403,405).

The apparatus 100 further comprises a spherical enclosure 500, which is formed by two halves in the form of a tracked hemispheric base 502 and a hemispheric cover 504 to enclose the gyro and motor assembly 450, and two U-shape support members 600,650 to connect the assembly 450 to the enclosure 500.

The two support members 600,650 are arranged to support the gyro and motor assembly 450 when the assembly 450 is being rotated as will be described below. The U-shape support members 600,650 are arranged at opposite ends of the gyro and motor assembly 450 as shown in FIGS. 2 and 3, and at ends of each support member 600,650 are lugs 602,604,652,654. Each lug has lug holes 602a,604a,652a,654a and when assembled in place, the lug holes are arranged to allow the geared wheels 108,110 to protrude through as shown in FIG. 6b.

At respective apexes of the U-shaped members 600,650, an aperture 606,656 is formed to receive a disc element 610,660 which connects the U-shaped members 600,650 movably to either the tracked hemispheric base 502 or the hemispheric cover 504 depending on the position of the U-shaped members, as illustrated in FIG. 6b.

As illustrated in FIGS. 4d and 6a, the base 502 has a cavity 502a arranged to receive part of the gyro and motor assembly 450 and a circular gear track 506 is arranged around the inner periphery or circumference of the base 502. The two gear-wheels 108,110 protruding through the lug holes 602a,604a,652a,654a are arranged to be meshed with teeth of the gear track 506 and as the shafts 102,104 spin or rotate about the Z-axis (in opposite directions as would explained later), the gear wheels 108,110 travel along the gear track 506 thus rotating the gyro and motor assembly 450 (and thus the flywheel 402) about the Y axis with respect to the base 502.

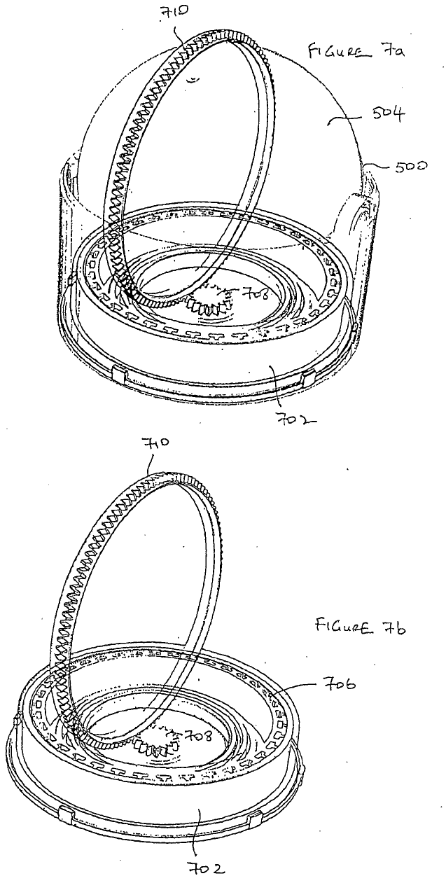

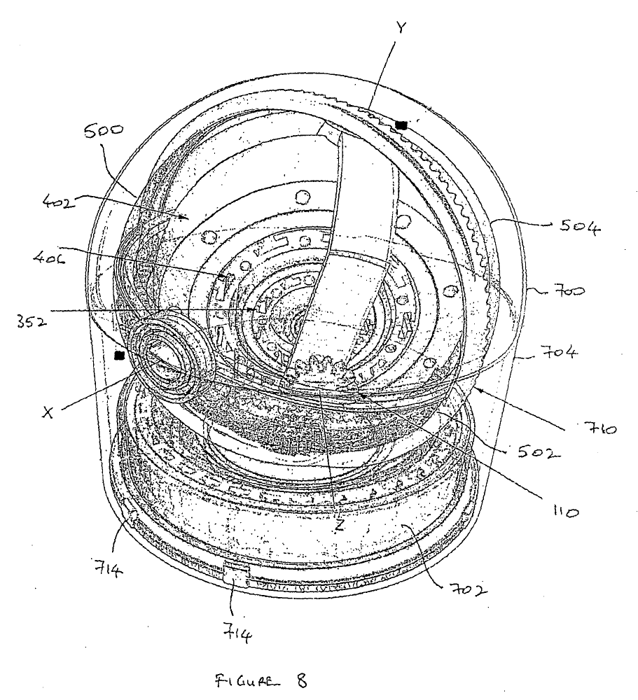

The apparatus 100 further comprises an apparatus housing 700 as shown in FIG. 1. FIG. 8 is a different view of the gyroscope apparatus of FIG. 1 with some of the parts made transparent to see the internal configurations. Further, one of the support members 600 is partly cut away (thus narrower than that shown in FIG. 1) to review more of the internal parts. The housing 700 has a circular base 702 and a housing cover 704. As shown in FIG. 7a, the base 702 includes a torque pinion gear 708 disposed at the centre of the base 702 and a low-speed D.C. motor 706 arranged to drive the pinion gear 708.

The apparatus 100 further includes a torque gear 710 having a bore 712 and an inner diameter which corresponds to the external circumference of enclosure 500 so that the torque gear 710 is disposed surrounding an outer periphery of the enclosure 500. The torque gear 710 and the enclosure 500 are in friction fit with each other such that the enclosure is movable in response to the movement of the gear 710.

Further, the torque gear 710 is arranged to mesh with the pinion gear 708 in a bevel gear arrangement as shown in FIGS. 7a and 7b, and due to the gear ratio, the torque gear 710 rotates at a much lower velocity than the pinion gear 708.

The housing cover 704 is preferably made of transparent plastics material and encloses the rest of the parts of the apparatus 100. The base 702 further comprises holders 714 arranged along the outer circumference of the base 702 and which is adapted to hold the cover 704 fixedly in place.

The apparatus 100 may be powered by internal batteries (not shown) located in the base 502 and includes wires (not shown) to supply power to the gyroscope 400 and the motors 300,350 are routed through the support members 600,650.

In use, when the flywheel 402 is spun about the Z-axis (being the spin axis) by the motor 404 from rest to a predetermined speed, it creates a large amount of angular momentum (the amount depends on the speed of spin and the mass of the flywheel) about the Z-axis. As is well known, a spinning gyroscope has a large amount of conserved physical energy and the gyroscope's angular to momentum tends to keep the apparatus in its initial direction. Further, the spinning gyroscope 402 has a precession plane which is a plane parallel to and having its centre at the Y-axis which is orthogonal to the rotation or Z-axis.

When the orientation of the apparatus 100 changes, this change can be detected by suitable angular sensors which provides a signal to drive the motors 300,350 which in turn drive the gear 239 and this sets the rest of the gear assembly 200 in motion depending on the direction of movement of the gear 239.

For example, if the gear 239 is driven in a clockwise direction by the motors 300,350 as shown by arrow A in FIG. 4a, the lower bevel gear 242 rotates in the direction indicated by arrow B1 whereas the upper bevel gear 240 rotates in the opposite direction indicated by arrow B2 (see FIG. 3). These bevel gears 240,242 thus drive the two shaft drive gears 244,246 in opposite directions as indicated respectively by arrows C1 and C2. The rotation of the drive gears 244,246 rotates the shafts 102,104 and thus moves the wheels 108,110 around the track 504 causing the gyroscope to precess about the Y-axis, which counter-balance the change in the orientation of the apparatus 100. In this particular example, due to the direction of rotation of the shafts 102,104, the wheels 108,110 (and thus the gyro and motor assembly 450) are being rotated in the direction indicated by arrow D as shown in FIG. 6a. The rotation of the spinning gyroscope about the Y-axis creates torque about a first torque axis which is orthogonal to the Y-axis (in this case, the torque axis is parallel to the X-axis) and such a configuration allows the gyroscope to create a first stabilising or reactive force about the torque axis.

In another configuration, the torque pinion gear 708 may be set in motion to rotate the gyroscope 402 about the X-axis thus creating a second stabilising or reactive force about a second torque axis which is orthogonal to the X-axis. Thus, it is apparent that the combination of the first and second reactive forces allows the apparatus 100 to create stabilising forces about two axes. It should also be apparent that the torque gear 710 may be positioned differently so that X-axis is at an oblique angle to the Y-axis. Advantageously, this can be used to produce a stabilising force about a desired axis by arranging the position of the torque gear with respect to the gear track 506 (which determines the angle between the X and Y axes).

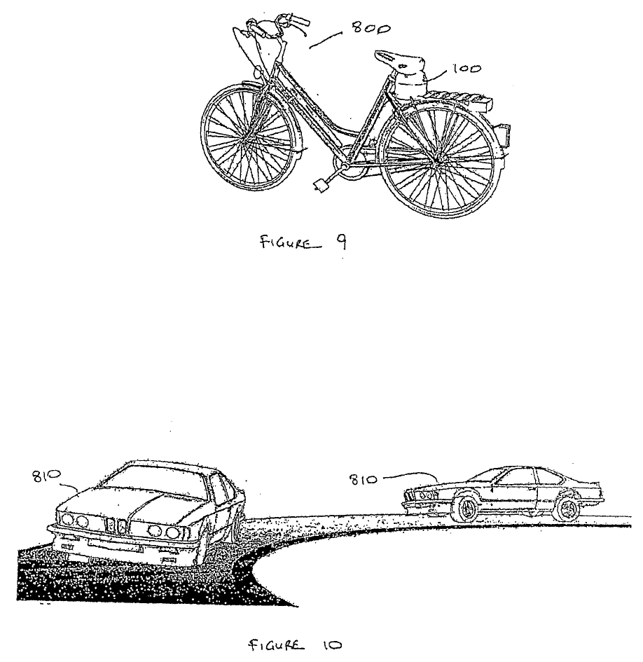

The arrangement of the gyroscope apparatus 100 of the described embodiment allows the apparatus 100 to be used in a variety of applications. For example, the gyroscope apparatus 100 may be used to balance a vehicle such as a bicycle 800 as shown in FIG. 9 (of course, the dimension and gyration of the gyroscope needs to be adjusted accordingly). In this way, the spinning gyroscope 400 can be used to balance the bicycle 800 in motion or when the bicycle 800 is at rest thus alleviating the need of the rider to use his legs to support the bicycle 800.

FIG. 10 illustrates another application example of using the gyroscope apparatus 100 to balance a vehicle in the form of a car 810. When the car 810 manoeuvres a corner or bend at high speed, centrifugal force may cause the to car to overturn. However, the gyroscope apparatus can be mounted anywhere in the car to create a stabilising force to reduce the chances of the car overturning when negotiating a bend at high speed.

In the bicycle 800 and car 810 examples, the motors 300,350,404 are standard motors arranged to rotate the gyroscope about the Y and Z-axes, which means that the motors need to be powered. However, since a moving object generates energy, the motors 300,350,404 can instead be a motor-generator” device which function as a generator and a motor, thus selectively storing energy when the bicycle or car is in motion or converting this stored energy to mechanical force to rotate the gyroscope 400. For example, when the bicycle is in motion, the movement creates inertia to freely rotate the flywheel 402 about the spin axis which can be used to store the energy created. Similarly, the bicycle's movement also causes the flywheel 402 to rotate about the Y-axis and this movement translates into rotational movement of two ring halves 220,230 functioning as rotors to create kinetic energy. Both the stored energy in the flywheel 402 and the ring halves 220,230 can then be used by the respective motor-generator devices to generate electricity to create the reactive forces to stabilise the bicycle when it is stationary. It should be apparent that the generated electricity can similarly be used to power other electrical devices for example a head light for the bicycle.

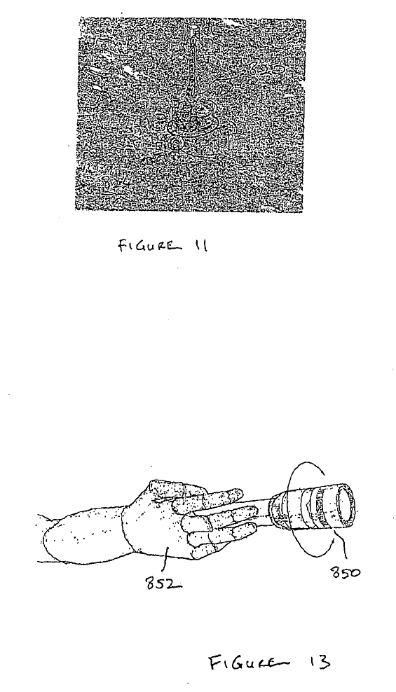

In yet another application, the gyroscope apparatus 100 is used in a buoy 820 supported by floats 822 out in the sea 824, as shown in FIG. 11. Preferably, the gyroscope apparatus 100 is fixedly located in one of the floats 822. Sea waves would urge the buoy 820 into motion and the “rocking” action rotates the flywheel 402 about the Y and/or Z axis thus producing energy which can be used by the motor-generator devices (which in this variation, the devices are adapted as generators) to generate electricity to power for example, warning lights produced from the buoys 820.

In another example, the apparatus 100 can be arranged as a generator when mounted in a torch-light 850 such as one shown in FIG. 13. The flywheel 400 of the apparatus 100 is freely rotatable about the Z-axis which is parallel to the length direction of the torch light and thus a simple rotation of the torch light 850 by a hand 852 can set the flywheel 402 in motion creating kinetic energy. The rotation of the torch light 850 similarly causes the flywheel 402 to rotate freely about the Y and/or Z-axis. The rotation is similarly used by the motor-generator devices to power a light source in the torch light 850. At the same time, if the flywheel 402 is sufficiently rotated, the current generated can be regulated to stabilise the position of the light beam from the light source.

As seen above, the use of a single gyroscope apparatus 100 provides active stabilisation along two axes but to produce stabilising forces along three axes, two gyroscope apparatus 100 need to be used, for example, as control moment gyroscopes (CMG) in aerospace systems such as a satellite. For this particular application, it is common to arrange four single-gimbal CMGs in a pyramid cluster arrangement such as that disclosed in the presentation by Dr Vaios J. Lappas entitled “Control Techniques for Aerospace Systems”. (available from: http://www.ae.inetu.edu.tr/˜ozan/control/index.shtml). Each CMG is rotated about the gimballed axis externally and thus this determines the extent to which the size of the CMG may be reduced. In the case of described embodiment of the present invention, the gyroscope 400 is gimballed about X and Y axes (Z-axis being the spin axis) and thus two gyroscopes apparatus 100 in combination may be used to produce stabilising forces about three axes. Further, since gear assembly 200 and the motors 300,350 to rotate the gyroscope 402 about the Y-axis is disposed inside the flywheel of the gyroscope, the gyroscope can be produced in a compact manner achieving a substantial reduction in size.

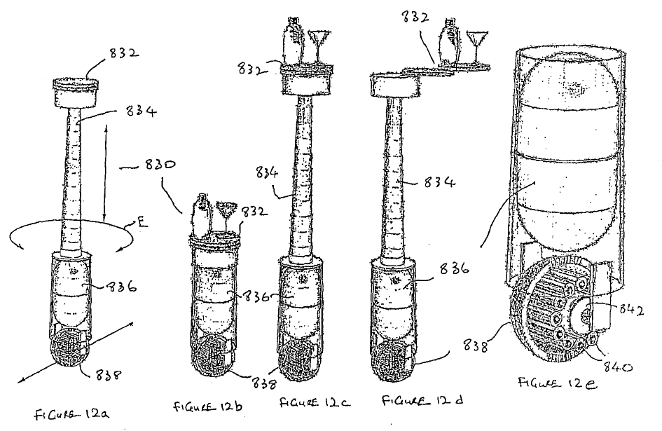

In a further example of stabilisation along three axes, two apparatus 100 of the described embodiment may be used to balance a wheeled support structure 830 such as that shown in FIGS. 12a to 12e. The structure 830 includes a circular support surface 832, an elongate and slightly tapered body 834 supporting the surface 832, a gyroscope housing 836 connected to the body 834 and a wheel 838 movably coupled to the gyroscope housing 836. Inside the housing 836 are two gyroscope apparatus 100 of the described embodiment arranged to balance the structure in an upright position and pivoted by the wheel 806.

The surface 832 may be arranged to support items such as glasses, bottles or other items for display such as that shown in FIG. 12c. The surface 832 may also be extended in the manner shown in FIGS. 12c and 12d and the structure 830 can still maintain its upright position due to the stabilising forces generated by the gyroscope apparatus 100. Thus, the body 834 is constantly rotating relative to the gyroscope housing 836 (see arrow E). Further, the body 834 may be retractable to become a compact structure such as that shown in FIG. 12b.

It would be apparent that a suitable positional sensor, mounted preferably on the housing 836, may be used to sense the deviation angle of the support structure 830 from the vertical axis which is fed to the gyroscope apparatus 100 for compensating the deviation.

FIG. 12e is a close-up view of the structure of FIG. 12a which depicts the housing 836 being located above the wheel 838. The wheel 838 is partly cut away to reveal batteries 840 and a motor 842 for moving the wheel 838. The batteries 840 can also be used to drive the motors 300,350,400 in the gyroscope apparatus 100. Further, it is envisaged that the gyroscope apparatus 100 may be disposed inside the wheel 838.

The operation of the two gyroscope apparatus 100 in FIGS. 12a to 12e can be understood by a skilled man and thus, this will not be explained in detail here.

As described above, the mechanical arrangement of the apparatus 100 is very compact and can thus be used in numerous applications since the flywheel 402 is disposed around the rotation device (i.e. motors 300,350 and gear assembly 200 are received in the cavity 401) and thus the flywheel 402 is rotated about the Y-axis from the inside of the flywheel 402 and not from the outside. Further, motor 404 for rotating the flywheel to create angular momentum is also located in the cavity 401 and this further makes the arrangement more compact. Preferably, the height or width of the apparatus 100 is less than double the diameter of the flywheel.

The described embodiments should not be construed as limitative. For example, the motors 300,350 can be stepper motors if the angle of rotation along the Y-axis is critical. Alternatively, the motors 300,350 can also be other is types such as linear motors depending on the application. However, the inventor prefers to use a motor-generator device since this allows the device to function as a motor and/or a generator depending on the application. Of course, control circuitry can be provided to switch the device's function.

In the described embodiment, the gear assembly 200 is used to rotate the shafts 102,104, but the motors 300,350 may be arranged to rotate the shafts 102,104 directly, and not necessary via the gear assembly 200.

Further, in the described embodiment, two pairs of stators and rotors 302,220,352,230 are used to drive the gear assembly 200 but this may not be necessary although preferred to provide more power. The D.C. motor 706 arranged to drive the pinion gear 708 can also be a stepper motor to produce accurate rotation of the flywheel about the X-axis. Further, the motor 706 can similarly be a motor-generator device so that an external inertia can be used to produce kinetic energy which can be used when the motor-generator is in motor mode.

It is also envisaged that the apparatus 100 can be used in numerous other applications and not limited to the application examples discussed herein.

Having now fully described the invention, it should be apparent to one of ordinary skill in the art that many modifications can be made hereto without departing from the scope as claimed.

1. Gyroscope apparatus comprising
a flywheel arranged to be rotated about a first axis; and
a rotation device arranged to rotate the flywheel about a second axis which is orthogonal to the first axis, the flywheel being disposed around the rotation device.

2. Gyroscope apparatus according to claim 1, further comprising a flywheel motor arranged to rotate the flywheel about the first axis, the flywheel being disposed around the flywheel motor.

3. Gyroscope apparatus according to claim 2, wherein the flywheel motor is disposed around the rotation device.

4. Gyroscope apparatus according to claim 2, wherein the flywheel motor includes a motor stator and a ring magnet, the ring magnet being rotatable in concert with the flywheel about the first axis.

5. Gyroscope apparatus according to claim 4, wherein the motor stator is annular shape.

6. Gyroscope apparatus according to claim 1, further comprising a flywheel motor-generator device selectively arranged to rotate the flywheel about the first axis or to convert the rotation of the flywheel into electrical energy.

7. Gyroscope apparatus according to claim 6, wherein the flywheel is arranged around the motor-generator device.

8. Gyroscope apparatus according to claim 1, wherein the rotation device further comprises a gear assembly arranged to rotate the flywheel, and a gear motor arranged to drive the gear assembly.

9. Gyroscope apparatus according claim 8, further comprising two axles arranged in end to end relationship along the first axis, the two axles being connected to the gear assembly.

10. Gyroscope apparatus according to claim 9, wherein the gear assembly includes
a pinion gear arranged to be driven by the motor,
first pair of opposing bevel gears meshed with respective parts of the pinion gear,
second pair of opposing bevel gears connected to the first pair of opposing bevel gears and being arranged to rotate in accordance with the first said pair, and
two opposing axle gears meshed with respective second pair of opposing bevel gears, each axle gear fixedly connected to a corresponding said axle, whereby rotation of the pinion gear rotates both axles in opposing directions to each other.

11. Gyroscope apparatus according to claim 8, wherein the motor is disposed around the gear assembly.

12. Gyroscope apparatus according to claim 8, wherein the motor includes a motor stator and a motor rotor, the rotor being disposed around the motor stator.

13. Gyroscope apparatus according to claim 12, wherein the rotor is arranged to enclose the gear assembly entirely.

14. Gyroscope apparatus according to claim 12, further comprising a ring magnet disposed between the stator and rotor.

15. Gyroscope apparatus according to claim 13, wherein the rotor includes two rotor halves and the gear motor includes two motor stators arranged to drive the respective rotor halves.

16. Gyroscope apparatus according to claim 15, further comprising two ring magnets, each magnet being disposed between corresponding rotor half and motor stator.

17. Gyroscope apparatus according to claim 12, wherein the pinion gear is connected to the rotor, the pinion gear being arranged to be rotated in response to the rotation of the rotor.

18. Gyroscope apparatus according to claim 15, wherein the pinion gear is connected to one of the rotor halves, the pinion gear being arranged to be rotated in response to the rotation of the connected rotor half.

19. Gyroscope apparatus according to claim 8, wherein the gear motor is a stepper motor.

20. Gyroscope apparatus according to claim 9, further comprising a wheel connected to a free end of each axle, the wheel being arranged to be supported on a circular support and being moved around the circular support by radial rotation of the corresponding axle.

21. Gyroscope apparatus according to claim 20, wherein the wheels are geared wheels and the circular support is a geared track.

22. Gyroscope apparatus according to claim 1, further comprising two side covers connected to sides of the flywheel to enclose the rotation device therebetween.

23. Gyroscope apparatus according to claim 1, further comprising means to rotate the flywheel about a third axis which is orthogonal to the first and second axes.

24. Gyroscope apparatus according to claim claim 1, further comprising means to rotate the flywheel about a third axis which is at an oblique angle with respect to the second axis.

25. Gyroscope apparatus according to claim 23, further comprising a flywheel enclosure, and a torque gear surrounding an outer periphery of the enclosure, the torque gear being rotatable to rotate the enclosure and the flywheel about the third axis.

26. Gyroscope apparatus according to claim 21, further comprising a flywheel enclosure, and a torque gear surrounding an outer periphery of the enclosure, the torque gear being rotatable to rotate the enclosure and the flywheel about the third axis, and wherein the geared track is disposed along an inner periphery of the enclosure.

27. Gyroscope apparatus according to claim 26, wherein the enclosure is spherical in shape and the torque gear is circular.

28. Gyroscope apparatus according to claim 25, further comprising a torque pinion gear meshed with the torque gear.

29. Gyroscope apparatus according to claim 28, further comprising a motor arranged to drive the torque pinion gear.

30. Gyroscope apparatus according to claim 29, wherein the motor is a stepper motor.

31. Gyroscope apparatus according to claim 28, further comprising a motor-generator device selectively arranged to drive the torque pinion gear or to convert movement of the torque pinion gear into electrical energy.

32. Gyroscope apparatus according to claim 1, wherein the rotation device further comprises a motor-generator device selectively arranged to rotate the flywheel about the second axis or to convert the rotation of the flywheel into electrical energy.

33. Gyroscope apparatus according to claim 32, wherein the rotation device further comprises a gear assembly selectively arranged to rotate the flywheel about the second axis or to be driven by rotation of the flywheel.

34. Gyroscope apparatus according to claim 1, further comprising a conversion device arranged to convert rotation of the flywheel into electrical energy.

35. Gyroscope apparatus according to claim 1, wherein the flywheel is annular.

36. A celestial device including at least one gyroscope apparatus according to claim 1.

37. A celestial device according to claim 36 wherein the device is in the form of a satellite.

38. A vehicle including at least one gyroscope apparatus according to claim 1.

39. A single-wheel vehicle including at least one gyroscope apparatus according to claim 1.

40. A household appliance including at least one gyroscope apparatus according to claim 1.

41. Gyroscope apparatus comprising
a flywheel arranged to be rotated about a first axis and a second axis which is orthogonal to the first axis; and
a conversion device arranged to convert the rotation of the flywheel about the second axis to electrical energy, the flywheel being disposed around the generator.
